(19) United States
(12) Patent Application Publication
(10) Pub. No.: US 2017/0286558 A1
(43) Pub. Date: Oct. 5, 2017

(54) Tracking Internet Sharing Using Augmented URLs

(71) Applicant: BuzzFeed, Inc., New York, NY (US)

(72) Inventor: Andrew Keats Kelleher, Brooklyn, NY (US)

(21) Appl. No.: 15/089,150

(22) Filed: Apr. 1, 2016

(51) Int. Cl. G06F 17/30; H04L 29/08

(52) U.S. Cl. CPC G06F 17/30887; H04L 67/02; H04L 67/10; H04L 67/22; G06F 17/30327; G06F 17/3089; G06F 17/30572; G06F 17/30377; G06F 17/3033; G06F 2201/835

(57) ABSTRACT

A tracking system receives indications of requests for webpages from browsers associated with users' client devices. Upon receiving an indication of a request for a webpage from a client device the tracking system identifies a client ID representing a sharing user associated with the client device. The tracking system hashes the client ID and appends it to the URL of the webpage creating an augmented URL. The browser of the sharing user is redirected to the augmented URL. When a receiving user represented by a different client ID uses the augmented URL to request the webpage, the tracking system determines that the sharing user must have shared the augmented URL with the receiving user and generates a user edge recording the sharing event. The tracking system organizes user edges from sharing events into tree structures and provides visualization functionality to webpage administrators interested in sharing patterns.

### BACKGROUND

### Field of Disclosure

This disclosure relates to the field of database management, and to real time tracking of content sharing events in a network.

### Description of the Related Art

Many websites and associated companies provide web content for free consumption by users on the internet. This practice can be motivated by the variety of factors whether it is to increase advertising viewership or to promote a particular cause or share an interest. Independent of motivation, operators of websites often want to increase the viewership of their web content. One significant way of increasing viewership of web content on the Internet is by Internet users sharing a hyperlink using a social network, email, or other communication media. These hyperlinks are either automatically generated and either copied from a browser URL bar and then pasted into a message or a message is automatically generated to contain the URL. These messages are sent to other Internet users. When web content is shared in this way, it has an opportunity to benefit from traffic generated by users continuing to share the content with each other, increasing the number of views for the web content as the content is shared between Internet users that often have many degrees of separation from the original users.

The particular qualities or sharing strategies that make some web content “go viral” while other web content is only shared within a small group is poorly understood, as adequate tools for tracking and visualizing hyperlink sharing in real time over a variety of media, are not available.

### SUMMARY

A tracking system receives an indication that a browser associated with a sharing user has requested a webpage. The webpage has a URL and the indication includes a client ID of the sharing user and a content ID representing the content on the webpage. The tracking system augments the URL of the webpage by appending a hash of the client ID of the sharing user to the URL of the webpage to create a first augmented URL. In some embodiments, the augmentation process is completed by appending a random salt to the client ID of the sharing user, and then using a suitable hashing algorithm to hash the client ID and random salt. The resulting hash is then appended to the URL of the webpage to create the augmented URL. The tracking system then transmits the augmented URL to the browser on the client device. This allows the browser to display the augmented URL in the URL bar. Once the webpage loads from an augmented URL; the tracking system records the webpage's unique ID as well as the unhashed user ID present in the augmented URL by which the user arrived on the webpage.

The tracking system 114 then receives an indication that a browser on a client device associated with a receiving user has requested the webpage using the augmented URL, the indication including a client ID of the receiving user, the client ID of the sharing user, and the content ID.

The tracking system creates a new augmented URL of the webpage by removing the hash of the client ID of the sharing user from the first augmented URL of the webpage and appending a hash of the client ID of the receiving user to the URL of the webpage. The tracking system generates a user edge based on the hash of the client ID of the sharing user, the client ID of the receiving user, the content ID, and a timestamp. The generated user edge contains the available information from the URL that the receiving user used to access the webpage to determine that the receiving user received the URL to the webpage from the sharing user. As the user edge is generated, the webpage is provided to the browser of the client device associated with the receiving user allowing the user to view the webpage.

The tracking system compares, based on edge logic, the generated user edge to one or more trees including a plurality of edges, each of the stored user edges having a content ID matching the content ID of the generated user edge. The edge logic include a series of logical tests that determine how the one or more trees with matching content IDs should modified based on the generated user edge, if at all.

The tracking system modifies the one or more trees in response to the comparison in step. The modifications to the one or more trees can include sub-tree migrations, appending the generated user edge to the one or more trees, deleting one of the stored user edges, and updating the timestamp of one of the stored user edges. The tracking system then generates a visualization of the modified one or more trees. The visualization may be a circle packing visualization 701.

### BRIEF DESCRIPTION OF DRAWINGS

FIG. 1 is a block diagram illustrating an embodiment of an environment for tracking and visualizing internet sharing in accordance with one embodiment.

FIGS. 2A-2D illustrate web browser and sharing interfaces at steps in a sharing event in accordance with one embodiment.

FIG. 3 is a high level block diagram illustrating the components of a tracking event in accordance with one embodiment.

FIG. 4 is a high-level block diagram illustrating a detailed view of the sharing module in accordance with one embodiment.

FIG. 5 is a conceptual diagram illustrating a user edge generated from a tracking event in accordance with one embodiment.

FIGS. 6A-6G are conceptual diagrams illustrating edge logic for a variety of incoming tracking events and states of hierarchical tree structure in the tracking database in accordance with one embodiment.

FIG. 7 is an illustration of an example tree visualized using a circle packing visualization in accordance with one embodiment.

FIG. 8 is a flow diagram illustrating a method for tracking internet sharing in accordance with one embodiment.

FIG. 9 is a block diagram of the components of a computing system for use as the server in accordance with one embodiment.

### DETAILED DESCRIPTION

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

The methods described here address the technical challenge of collecting Internet sharing data for web content in real time. Tracking Internet sharing is inherently difficult because Internet users share content using hyperlinks on a wide variety of messaging platforms and social media networks. Thus, it is essentially impossible for a single website to track all possible methods of communicating a hyperlink between users by monitoring those communications directly. In addition, many hyperlinks, especially for viral web content, are shared at an extremely high rate and, often, multiple times between the same users, making it difficult to determine the relationship between the sharer and the receiver of the hyperlink. The methods describe here address these technical problems, allowing for the collection of sharing data including the number of users that viewed an item of content, the propagation of the content among those users, and the time at which each sharing event occurred. In addition, the sharing data is de-duplicated in real time, preserving only the sharing event that resulted in the original transfer of content knowledge between the viewing users.

Website operators that wish to make decisions regarding content subject matter or content placement can take advantage of this technical solution when producing and sharing content, as they are able to determine from sharing data which types of content are more favorable to their Internet audience, and which segments of their audience will more readily engage with a particular piece of content. Many websites that provide free content derive their revenue from advertising and so an increase in viewership through retrospective analysis of previously shared web content could directly impact a website's financial success. For example, through analysis of Internet sharing data, a website operator may determine that the number of views for their web content exponentially increases when a user posts a link to the content on a particular social network. Using this sharing data, the manager may choose to post their web content directly to that social network in the future to increase the likelihood of receiving a large number of views.

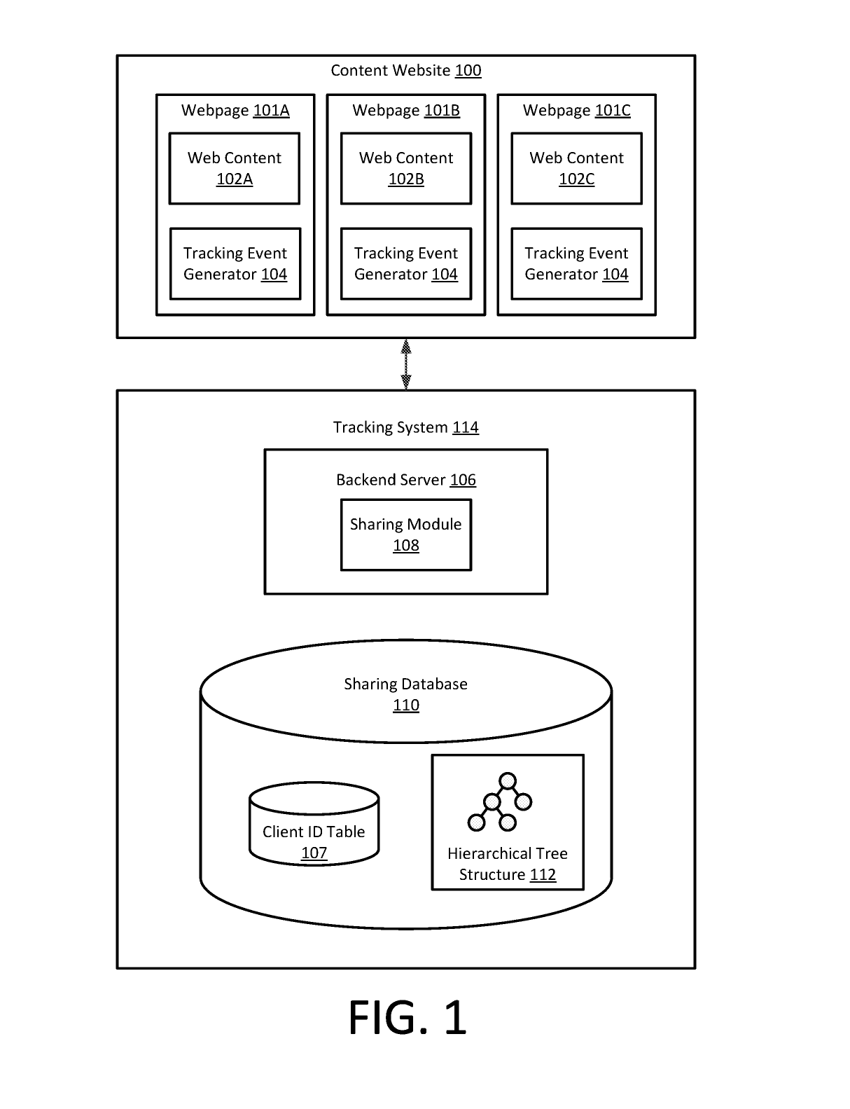

FIG. 1 is a block diagram illustrating an embodiment of an environment for tracking and visualizing internet sharing in accordance with one embodiment. The environment includes a content website 100, a backend server 106, and a sharing database 110, which together comprise the tracking system 114. Tracking system 114 provides a website 100 to users and tracks internet sharing events between those users accessing the website 100.

The tracking system 114 delivers content of the content website 100 to browser applications on client devices of internet users through requests over the internet. The content website 100 is comprised of a number of webpages 101 where each webpage 101 includes web content 102. In addition, each webpage 101 on the website 100 contains an instance of a tracking event generator 104 instantiated in HTML or another markup language in the webpage code.

In FIG. 1, three examples of webpages 101A, 101B, and 101C are shown with corresponding web content 102A, 102B, and 102C. Each instance of the tracking event generator code contains the same instructions and so they are not distinguished from one another even though they are instantiated on different web pages.

Each web page 101 typically includes graphics, navigation interfaces (such as a website search bar, content categories, advertisements, sharing options etc.) in addition to the web content 102. Web content 102 may refer to any type of content that may be presented on a web page 101, including but not limited to text, audio, video, or interactive media such as games, quizzes, surveys, or any combination of the forgoing types of media. A website 100 utilizing the method for tracking internet sharing disclosed herein typically uses a different webpage 101 for each item of distinguishable web content 102 for which the operators of the website 100 wish to capture sharing data. This is because the method described herein tracks sharing behavior on a per-URL basis.

The tracking event generator 104 is a section of HTML and javascript code that creates a tracking event whenever a user accesses a webpage 101. In one embodiment, the tracking event generator code is located in the header and footer of the HTML code for the webpage 101. The first section of the tracking event generator 104 identifies an internet user based on a persistent anonymous identifier.

The persistent anonymous identifier may be a cookie retained on the browser of the internet user, an identifier in local storage of the client device of the internet user, or an identifier in the keychain of the client device of the internet user. In any of these cases, the persistent anonymous identifiers should be as persistent as possible on the user's client device to provide a concrete point of identification of that user whenever they access webpages 101 on the website 100. The tracking event generator 104 detects the persistent anonymous identifier on the client device of the user accessing the webpage 101. If no persistent anonymous identifier is present on the client device of the user the tracking event generator saves a persistent anonymous identifier to the client device of the user (or saves a cookie to the user's browser as the case may be). Each persistent anonymous identifier is associated with a client identification number (client ID) and stored along with its associated persistent anonymous identifier in the client ID table 107 on the backend server 106.

Client IDs are randomly selected integers within a bounded range. For example, client IDs may be in the set of ten-digit integers between 0 (0,000,000,000) and 9,999,999,999. Any suitable range may be chosen for the client IDs as long as it is large enough such that the likelihood of choosing a duplicate client ID for two persistent anonymous identifiers is vanishingly small. In addition multiple consecutive ranges of integers may be chosen to provide further identification information from the client ID alone. For example, integers 0 to 10 billion might represent desktop and mobile web clients, while integers 10 billion to 25 billion might represent iOS and Android clients.

After detecting the persistent anonymous identifier, the tracking event generator 104 retrieves the client ID from the client ID table 107 on the backend server 106. The tracking event generator 104 then appends a randomly selected salt to the beginning of the client ID. The random salt is a multiple digit integer value of a consistent length. If a two-digit random salt is used, two randomly selected digits are appended to the client ID. For example, if the tracking event generator 104 detects a persistent anonymous identifier that is associated with a client ID of 2,693,423,179 and the tracking event generator 104 selects a random salt of 47, the tracking event generator appends the random salt to the beginning of the client ID, resulting in the integer 472,693,423,179. In some embodiments, the salt can be used to modify client ID in other ways. For example, the random salt could be appended to the end of the integer or a mathematical operation could be performed using the random salt and the client ID.

The resulting integer is then hashed using a suitable reversible hashing function. For example, the integer 472,693,423,179 might be converted to the hash XJynoGGrvGv. Once the hash of the client ID and random salt is generated, the tracking event generator 104 appends a hash indicator such as the “#.” (or any other character or sequence of characters) followed by the hash itself to the end of the URL. The augmented URL is a likely unique URL that can be unhashed to determine the client ID. For example, if the base URL for a page is www.buzzfeed.com/dbrownstone/the-10-cutest-puppies-youve-seen, then the augmented URL could be

augmented URL couldwould be www.buzzfeed.com/dbrownstone/the-10-cutest-puppies-youve-seen#.XJynoGGrvGv, or www.buzzfeed.com/dbrownstone/the-10-cutest-puppies-youve-seen?utm_term=XJynoGGrvGv given the client ID and hash discussed in previous examples. The new URL is displayed in the URL bar of the browser instead of the original URL even if the original URL was used to reach the webpage 101. This may be accomplished through a URL redirect from the original URL to the augmented URL.

The process of hashing the value obfuscates the client ID used by the internet sharing tracking system from the user while the addition of the random salt to the client ID ensures that a new hash is generated each time the user visits a webpage 101. If the same hash or client ID was appended to the URL when a persistent anonymous identifier was detected, anyone could find the ID or hash associated with a particular user and then search the internet for appearances of that character sequence. This might reveal the search history of the user. Because the tracking event generated 104 creates a different hash each time a user visits a webpage 101 it is impossible to track a particular user without access to the hash function used, which protects user privacy.

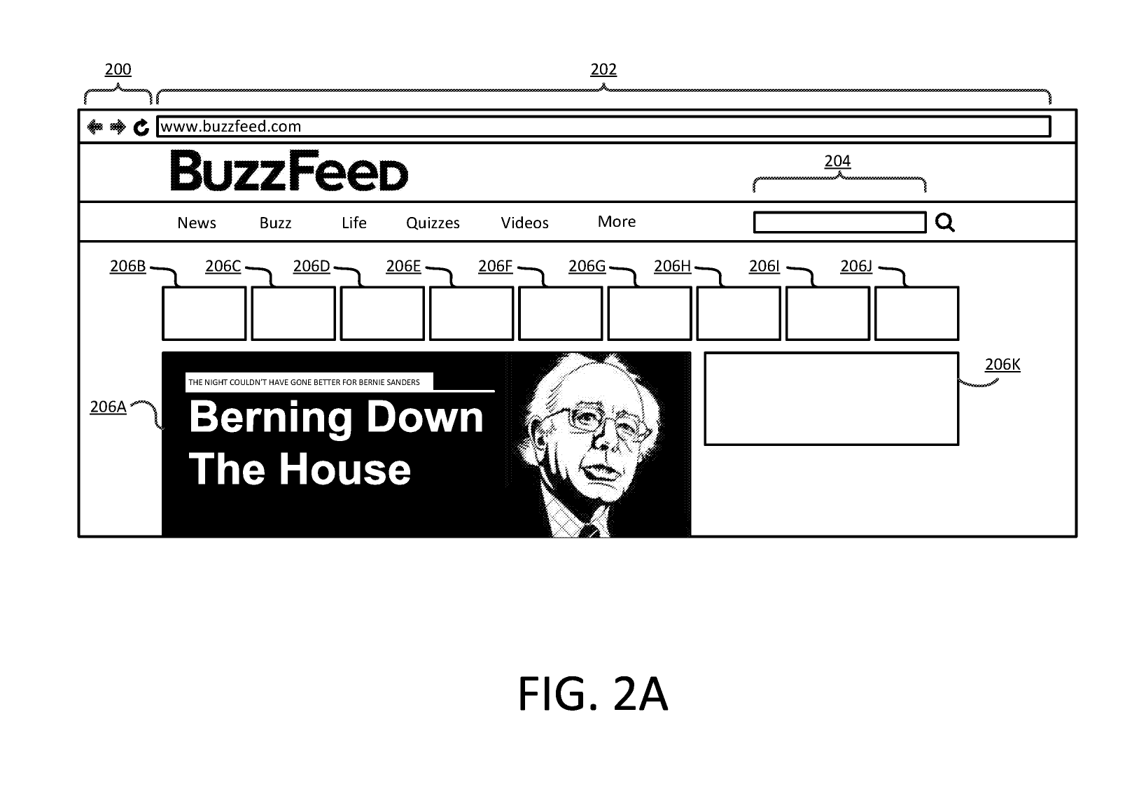

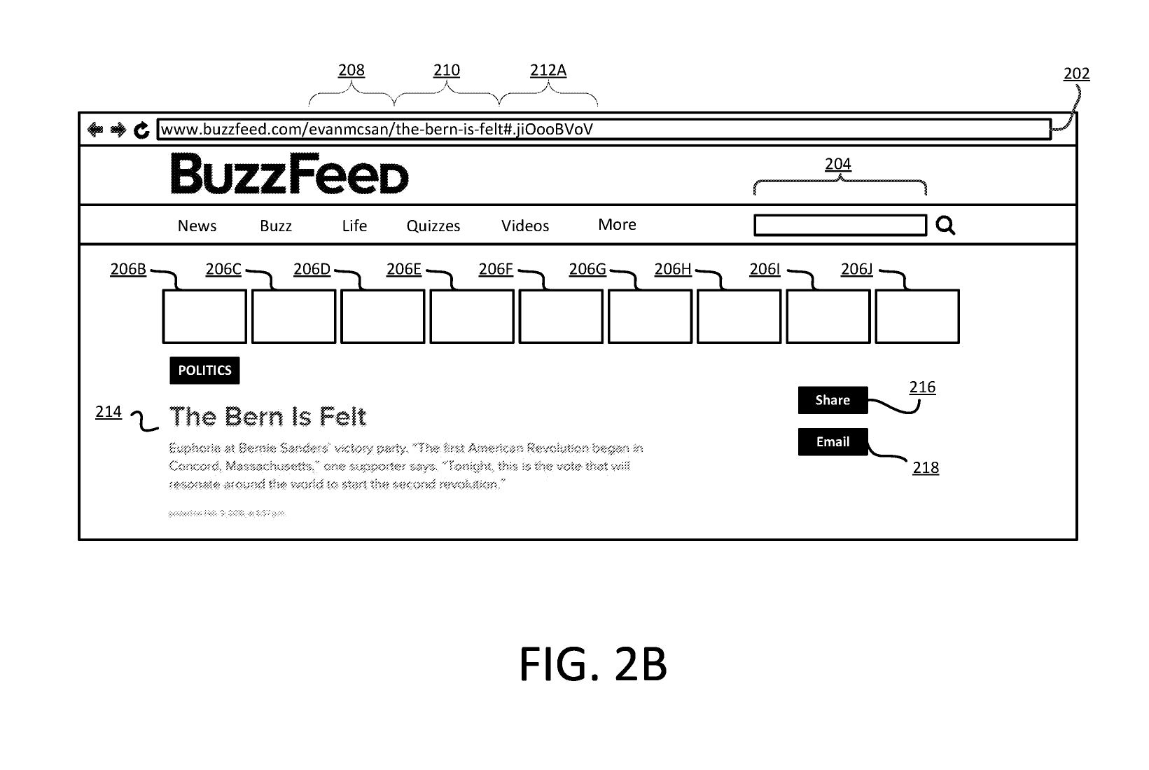

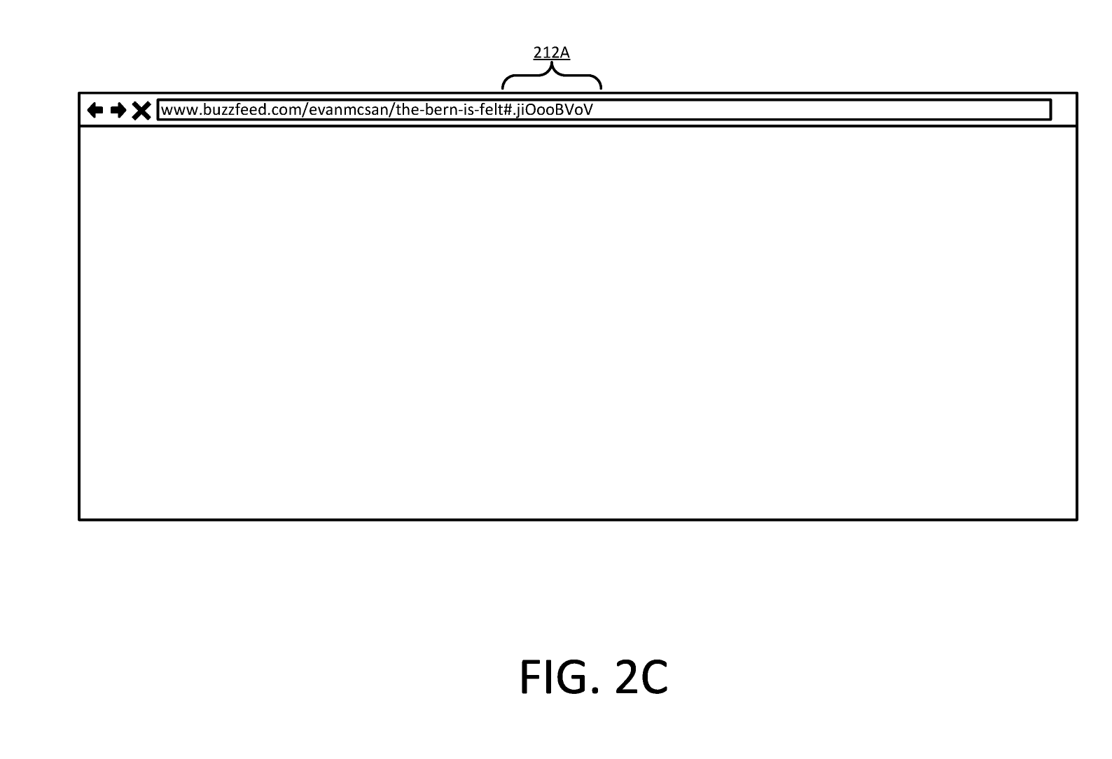

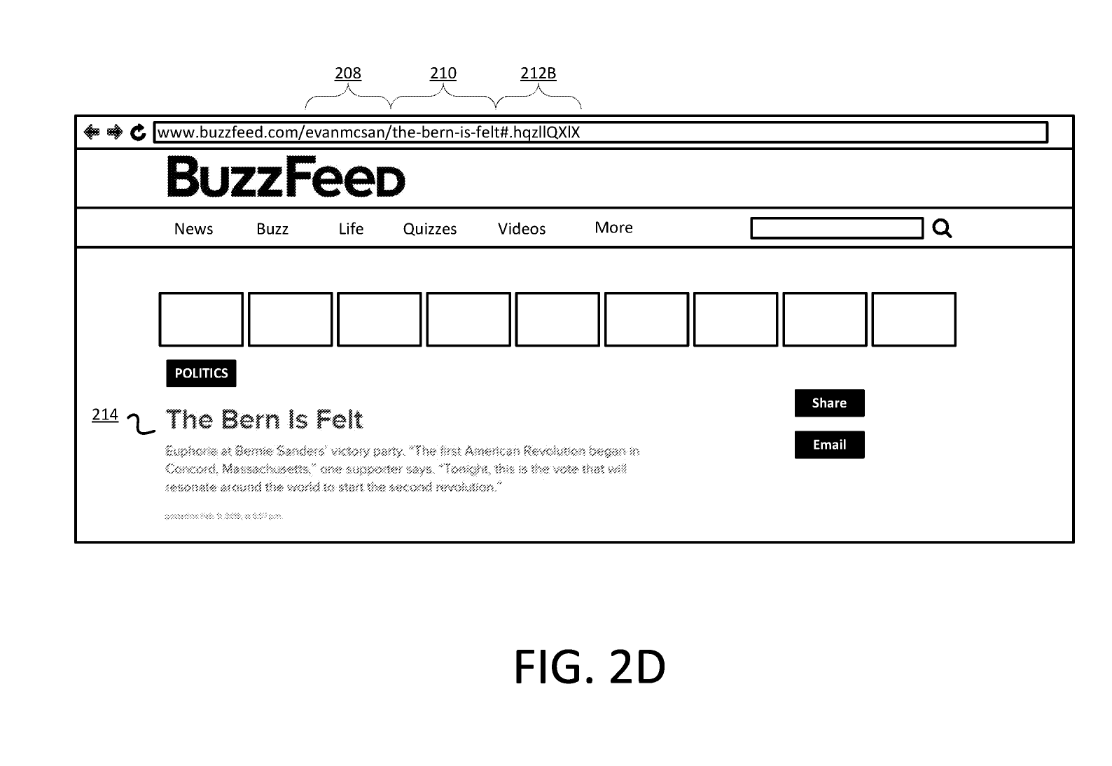

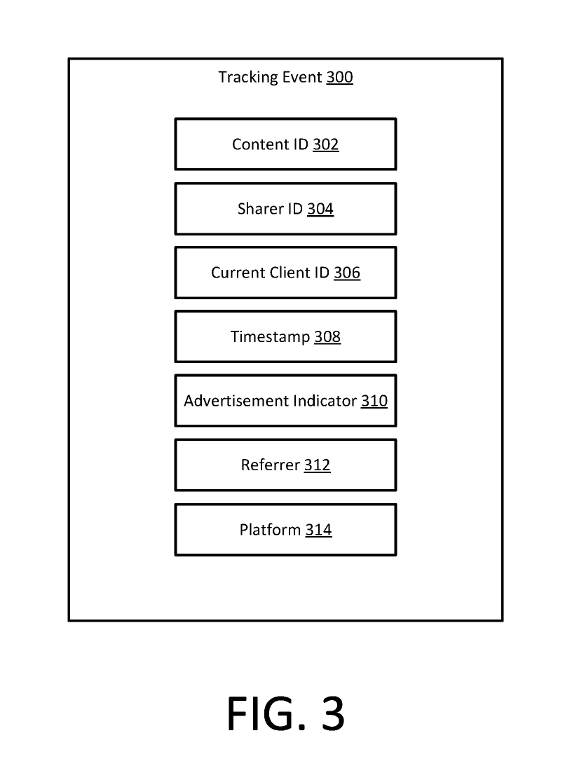

In addition to appending the hash value to the URL of the webpage 101, the tracking event generator 104 checks the URL used to locate the webpage 101 to see whether a hash is present in the initial URL. If a hash is present, the original hash is removed and replaced with the new hash. Before removing the hash, however, the tracking event generator 104 determines the corresponding client ID for the hash, by removing the random salt at the beginning of the hashed value and unhashing the hash value. Depending on the embodiment, the tracking event generator may unhash the have value before removing the salt if the salt was added before hashing when the augmented URL was created. The client ID of the incoming URL can then be compared to the client ID for the generated URL to determine the value for the attributes of a sharing event. If a second user uses a URL generated for a first user it can be inferred that first user shared the webpage 101 with the second user. The tracking event generator 104 uses the client IDs and other information available from the webpage 101 to create a tracking event. FIGS. 2A-2D illustrate a typical example of a sharing event and the process of appending a hashed identifier to a URL for a webpage 101, while FIG. 3 describes the details of the data included in a tracking event.

FIGS. 2A-2D illustrate a web browser and user interface during a sharing event in accordance with one embodiment. FIG. 2A illustrates a homepage for a website, in this example buzzfeed.com. The browser interface includes browser controls 200, URL bar 202, website search bar 204, and web content regions 206A-206K.

Browser controls 200 are controls provided by the user's browser and may include forward, back, and refresh buttons or any other typical browser functions. URL bar 202 is a text input field that receives user text input for a URL while also displaying the current URL of the webpage displayed by the browser. In FIG. 2A, the URL bar 202 displays the URL of the homepage of the website “www.buzzfeed.com.”

Website search bar 204 is a text input field on the homepage of the website 100 for searching web content 202 on the webpage. The website may use any search algorithm to retrieve web content according to search terms entered in the website search bar 204.

Web content regions 206 are regions of the homepage, or any other webpage 101 of the website 100 that upon receiving an interaction from a user within the region 206 the browser follows a hyperlink to the web content 202 indicated in the region. Web content regions 206B-206K would normally include images indicating their linked web content 202, however they are left blank here for ease of illustration. In some embodiments, each region 206 of homepage is assigned an identifier, as a client would be assigned a client ID, so that sharing data resulting from users accessing web content 202 via that region 206 could be tracked. For example, the operator of the website 100 might hypothesize that the large region 206A of the homepage might provide a greater opportunity for viral sharing than other regions 206 on the homepage. Thus, it would be useful to track sharing chains that begin at that location of the homepage to see whether placing web content in that region 206A promoted viral growth. A sharing chain is a number of sharing events that are causally connected. For example, if user 1 discovers web content 102 posted in web content region 206A and then shares it with user 2, and user 2 then shares the web content 102 with user 3, the sharing chain between web content region 206A and user 3 would include each of the aforementioned sharing events.

Web content 202 located through the use of the search bar 204 may also be given a tracking ID to determine the virality of items that have been located through the search bar.

FIG. 2B illustrates the result of a user selecting the web content region 206A that links to the article, “The Bern is Felt.” In this case, the tracking event generator 104 would register a tracking event indicating the user was referred to the webpage 101 by the web content region 206A. The tracking event generator 104 also identifies the persistent anonymous identifier of the user and generates a unique hash for the user (including the random salt and the client ID). The tracking event generator 104 then appends the hashed identifier to the URL of the webpage 101 for display in the URL bar 202, creating an augmented URL. In this embodiment, the webpage URL contains all of the necessary information to generate a tracking event. The augmented webpage URL contains an author name abbreviation 208, a web content abbreviation 210, and hashed client ID of a first user 212A. The webpage 101 also includes the content 214 of the webpage and other web content regions 206B-206J with which the user may interact. Lastly, webpage 101 of FIG. 2B includes a sharing button 216 and an email button 218.

The sharing button 216 allows a user to share the webpage 101 with users on other websites including social media websites or blogs. The webpage 101 may have multiple sharing buttons 216, each corresponding to a different popular social networking website. Each sharing button is designed to be indicative of the social networking website associated with the button and may be implemented using third party APIs. Upon receiving an interaction with the sharing button 216 from the user, the browser allows the user to share the web content 214 on the social networking website associated with the button 216. Depending on the functionality of the social networking website, the browser may share the webpage 101 by navigating to a particular page on the social networking website, by launching a pop-up window or web application with which to share the webpage 101, or by using any other suitable method for sharing a hyperlink. Sharing the webpage 101 including the web content 202 comprises creating a post to the social networking website including a hyperlink of the webpage 101. The sharing button 216 automatically creates the hyperlink using the URL displayed in the URL bar 202, which includes the hashed client ID of the first user 212A.

The email sharing button 218 allows a user to share the webpage 101 via email with one or more email addresses provided by the user. Once the user inputs one or more email addresses the browser generates one or more emails each containing a hyperlink to the webpage 101, which includes the hashed client ID of the first user 212A. The browser may create the emails using a native application on the client device or by navigating to an email web application in the browser. In some embodiments the email may contain a preview of the web content 202 on the shared webpage 101. In some embodiments, the hyperlink may be embedded in the preview.

FIG. 2C illustrates a browser loading the webpage 101 after a second user clicks on a shared hyperlink including the hashed client ID of the first user 212A. FIG. 2C illustrates the page loading with the original hyperlink including the hashed client ID of the first user 212A. As the page begins to load, the tracking event generator 104 detects that the second user does not match the hashed client ID 212A, and generates a tracking event. While generating the tracking event, the tracking event generator 104 retrieves the client ID of the second user and hashes it.

FIG. 2D illustrates a browser of the second user displaying the webpage 101 and the web content 214. Upon completion of loading the webpage 101 the URL bar 202 displays an new URL when compared to the URL that was used to reach the webpage 101. The new URL has the same author name abbreviation 208 and web content abbreviation 210 as the originally generated URL, however the hashed client ID of the second user 212B replaces the hashed client ID of the first user 212A.

In response to the tracking event generator 104 detecting a second user accessing a webpage 101 using a hyperlink including a hashed client ID of a first user (or ID for a region 106 of the homepage or search bar 104), the tracking event generator 104 generates a tracking event. FIG. 3 is a block diagram illustrating the components of a tracking event 300 in accordance with one embodiment. A tracking event 300 includes a number of informational fields including at least a content ID 302, a sharer ID 304, a current client ID 306, a timestamp 308, an advertisement indicator 310, a referrer 312, and a platform 314.

The content ID 302 is an identification value indicating the web content 202 for which the tracking event 300 has been generated. For example, if an article about presidential candidate Bernie Sanders is shared, the content ID 302 will be an ID associated with that particular article. Tracking events 300 that include the same content ID 302 are analyzed together to determine trends about a how particular examples of web content 202 are shared across the internet.

The sharer ID 304 is the client ID of the first user that shared the web content 102 with the second user. In the example illustrated in FIGS. 2A-2D, the sharer ID 304 would be the unhashed version of the hashed ID of the first user 212A.

The current client ID 306 is the client ID associated with the user currently loading the webpage 101 that generated the sharing event. In the example illustrated in FIGS. 2A-2D the current client ID 306 would be the unhashed version of the hashed ID of the second user 212B.

The timestamp 308 is a date and time recorded at the moment the tracking event is generated indicating the time at which the sharing between the two users occurred. In some embodiments, the timestamp 308 is a Unix timestamp.

The advertisement indicator 310 is a binary value that indicates whether the shared hyperlink was located in an advertisement. In this case, the URL would contain an additional field indicating that the hyperlink was part of an advertisement in addition to the hashed client ID.

The referrer 312 is a value indicating whether the hyperlink was shared on a commonly used social network. For example, when a sharing button 216 is used to share a hyperlink on social network A, the referrer for any resulting sharing event would be social network A. An additional indicator may be added to the hyperlink shared on a particular social network identifying the social network as the referrer such that when a second user activates the hyperlink the tracking event generator 104 can determine the referrer of the hyperlink. Alternatively, the tracking event generator 104 may determine based on the browser history that the user interacted with the hyperlink on a webpage associated with a particular commonly used social network.

The platform 314 is a field indicating whether the sharing occurred on a mobile device such as a smart phone or tablet or if it occurred over a desktop browser. The tracking event generator 104 retrieves this information from the browser executing the HTML code for the webpage 101 if the browser is compatible.

After the tracking event 300 has been created, the tracking event generator 104 may store the tracking event 300 on the hard drive of the client device. Saving the tracking event to the client device as opposed to immediately transmitting it to the backend server 106, prevents the loss of sharing information if the user cancels the webpage 101 before the webpage 101 has finished loading. This is because transmitting the tracking event 300 to the backend server 106 takes significantly longer than storing the tracking event 300 on the client device. If the user cancelled or closed the webpage 101 before the tracking event 300 had been transmitted, data would be lost. Storing to the client device increases the probability that the tracking event will be saved and tracking data will not be lost. In an embodiment where an operator of a website 100 is only concerned with tracking events 300 where the users have had the opportunity to view the web content 102 on a web page then the embodiment might instead have the tracking event generator 104 transmit the tracking event directly to the backend server 106 since in that case the a cancelled webpage 101 would not be enough to count as a view.

Because the previously described functions of the tracking event generator 104 are time sensitive, in one embodiment the HTML instructions for these tasks are provided in the header of the webpage's code. When the tracking event generator code is placed in the header, the generated tracking event 300 will be more likely to be saved in case the webpage 101 is cancelled, closed, or fails for any other reason. This results in a more robust data gathering method.

The tracking event generator 104 also includes non-time sensitive tasks, which may be included later in the HTML script for the web page 101, for example in the footer of the code. Each time a particular user accesses a webpage 101 on website 100, the tracking event generator 104 stores a tracking event on the client device of that user. The tracking event generator 104 monitors the number of tracking events stored on the client device and, when the number of tracking events reaches a threshold (for example 20 tracking events), the tracking event generator 104 transmits the batch of locally stored tracking events to the backend server 106 for further processing and clears the memory on the client device allocated for tracking events so that additional tracking events can be stored. In some embodiments, instead of a using a threshold number of tracking events, the tracking event generator 104 may transmit stored tracking events to the backend server 106 after a predetermined time period.

Note that the tracking event generator 104 for a particular webpage 101 will transmit tracking events that were created for any other webpage 101 on the same website 100. This means that the user does not have to wait long enough for tracked events to be sent from a single webpage and can instead visit any page on the website to trigger the transmission of stored tracking events to the backend server 106. This works well for frequently visited websites 100 as the vast majority of users will visit the website 100 again in the future. However, in embodiments where the website 100 is not as frequently visited, the operator of the website 100 might reduce the transmission threshold or time period for tracking events so that fewer visits to the website are required to receive tracking data. Alternatively, a low traffic website may choose to transmit the tracking events when they are generated instead of storing them on the user's client device.

The backend server 106 may be a single server or a server system that serves web content 102 to client devices of internet users visiting the website 100. In addition to providing functions typical of a web server, the backend server 106 contains code for the sharing module. The backend server 106 also communicates and modifies the sharing database 110, which contains the client ID table 107. The client ID table 107 stores all client IDs generated by the tracking event generator 104 and relates them with persistent anonymous identifiers. The backend server 106 identifies when a client device of a user does not have a persistent anonymous identifier and assigns an identifier. Whenever a persistent anonymous identifier is created for a user, a new entry is created in the client ID table 107. The tracking event generator 104 will then provide the associated client ID to the client ID table. The tracking event generator queries the client ID table 107 whenever it detects a persistent anonymous identifier in order to retrieve the corresponding client ID.

The sharing module 108 is responsible for filtering and analyzing transmitted tracking events in order to create useful data for a website operator. The sharing module 108 takes in tracking events from client devices and generates user edges defining an sharing event between two users for a particular webpage 101 and corresponding web content 102. After generating a user edge for each tracking event received, the sharing module 108 makes modifications to the sharing database 110 after comparing the generated user edge to preexisting edges stored in the sharing database 110 based on edge logic.

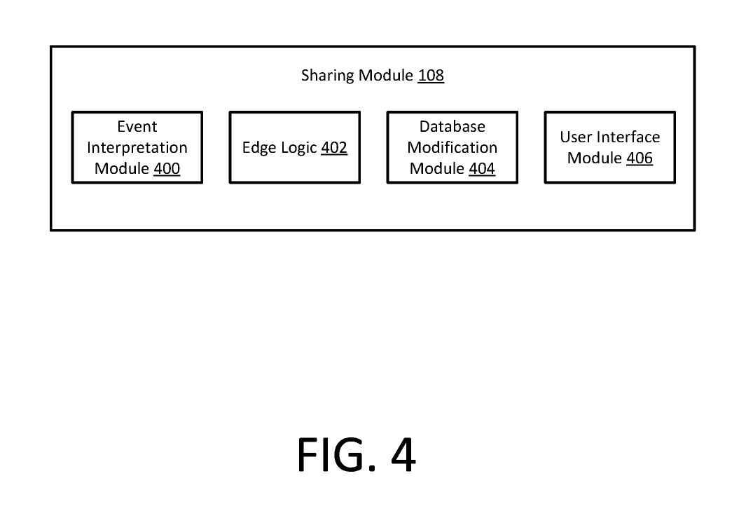

FIG. 4 is a block diagram illustrating a detailed view of the sharing module 108 in accordance with one embodiment. The sharing module 108 has four sub-modules that perform the functions of the sharing module 108 including the event interpretation module 400, the edge logic module 402, the database modification module 404, and the tree visualization module 406.

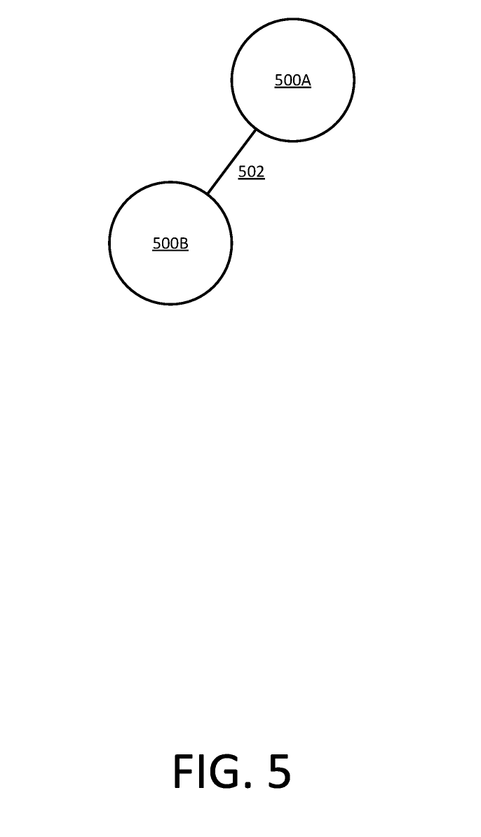

The event interpretation module 400 receives tracking events 300 from tracking event generators 104 and creates a user edge for the sharing database 110. A user edge is a database object indicating that a sharing event occurred between two users at a particular time. FIG. 5 is a conceptual diagram illustrating a user edge 502 generated from a tracking event 300 in accordance with one embodiment. For the purposes of illustration, nodes 500 towards the top of the page along a user edge 502 represent the sharer ID while the node at the bottom of the user edge 502 represents the current client ID. The user edge 502 is shown between two nodes 500A and 500B. Each node 500 is a database object that is associated with a particular client ID in the client ID table. A node 500 is also associated with a content ID 302. Thus a node 500 may exist for each combination of a single user with a single item of web content 102. User edges 502 may only exist between nodes 500 associated with the same content ID 302. User nodes 500 and user edges 502 are stored on sharing database 110 in a hierarchical tree structure 112.

Sharing database 110 is a database that may be implemented with any suitable database software. Sharing database 110 may be implemented on the same server as the backend server 106, a different server from the backend server 106, or the sharing database 110 may be implemented on multiple separate servers. The sharing database 110 contains nodes 500 and user edges 502 organized by content ID 302. Each content ID 302 may be associated with a single tree or multiple trees depending on whether the web content 102 was seeded from one source or many sources. For example, if the original URL of a webpage 101 was posted to a social network as a promotion and was posted to the BuzzFeed homepage at the same time section of the sharing database 110 for the content ID 302 associated with that webpage 101 would have two trees with a superior node for the social network promotion and the BuzzFeed homepage respectively. Each tree in the sharing database 110 is directed and acyclic.

Sharing module 108 has edge logic module 402, which determines the formation of nodes 500 and user edges 502 in sharing database 110. Edge logic module 402 is a series of logic tests that establish a set of rules for incoming user edges 502 from the event interpretation module 400. The edge logic module 402 is designed to ensure that a continuous chain of user edges is created between each subordinate node 502 and the originating node 502 at the top of the tree. In addition, the edge logic module 402 maintains the directed and acyclic nature of the graph. Because only one edge 502 can exist between nodes in the database only the first tracking event indicating sharing between two users is recorded in the sharing database.

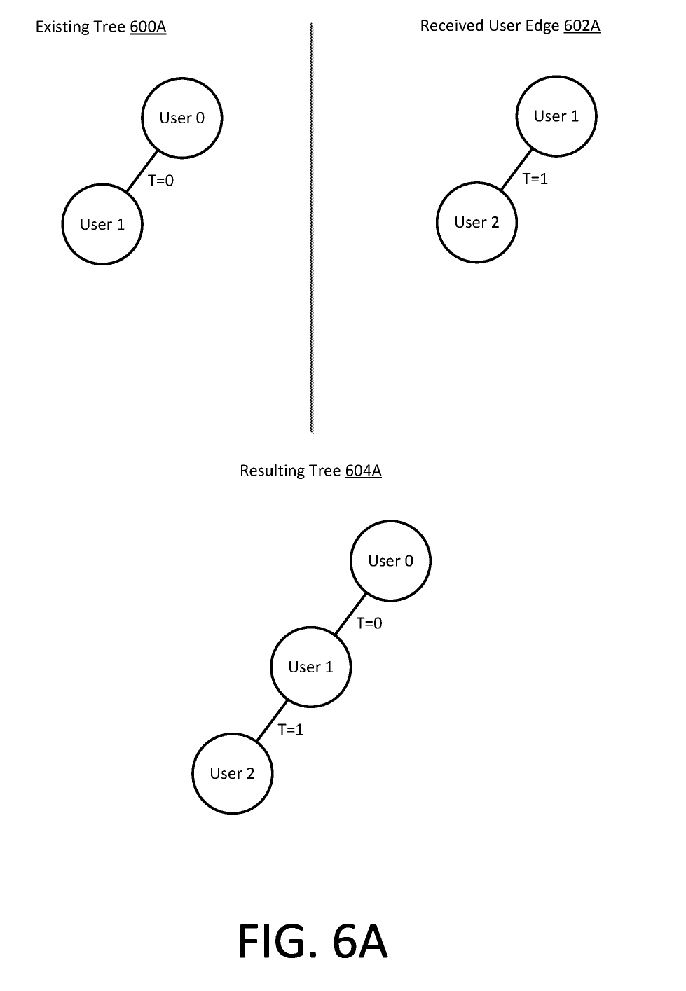

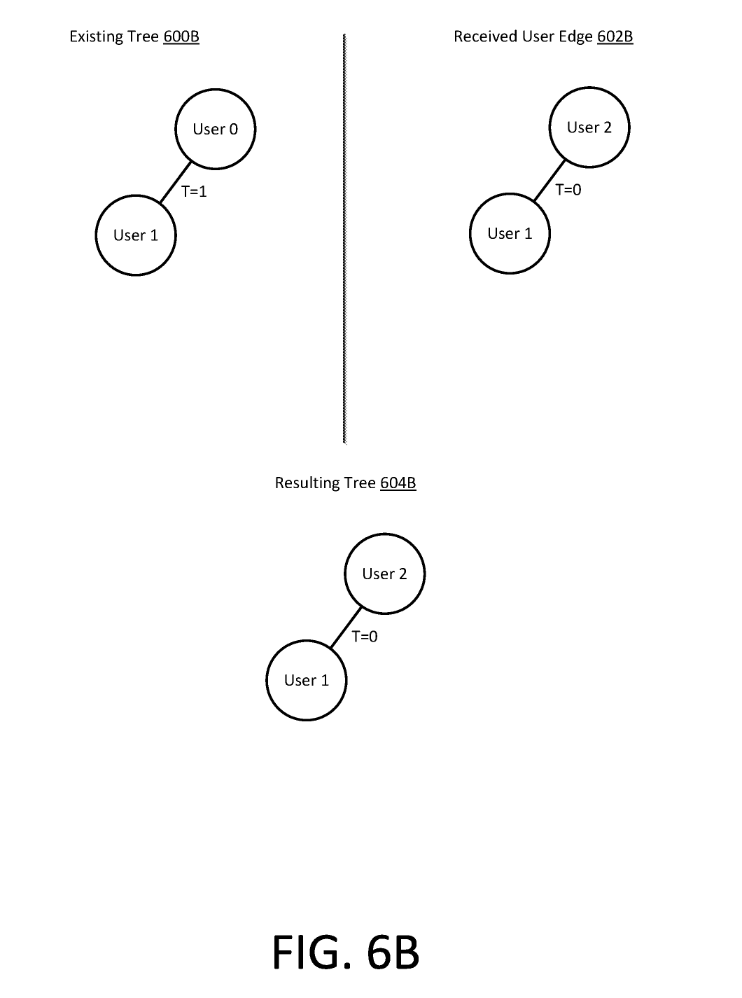

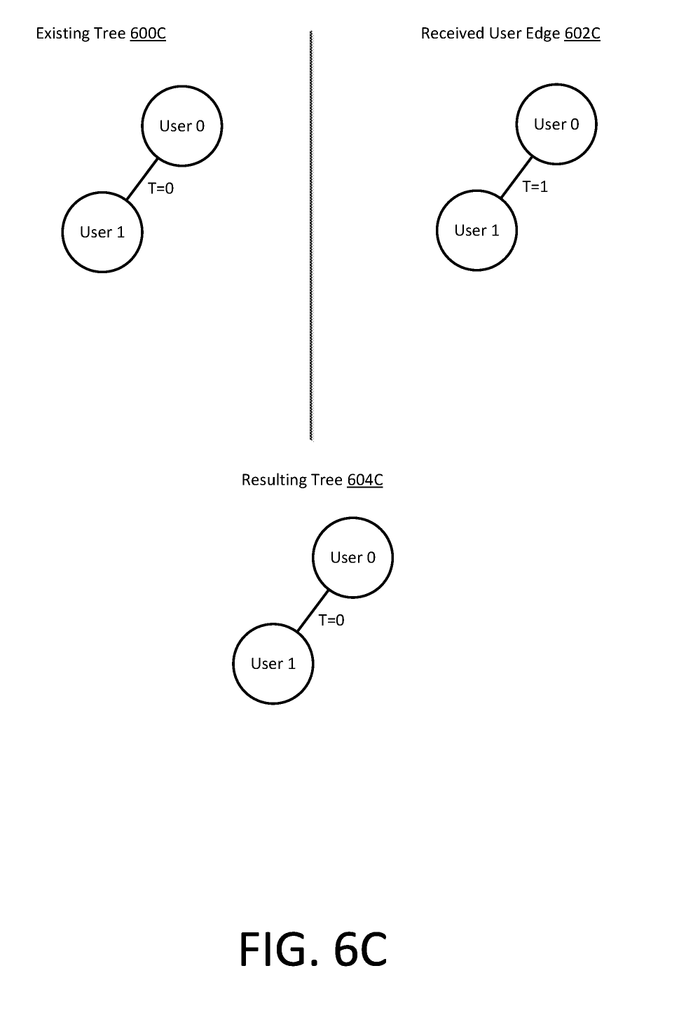

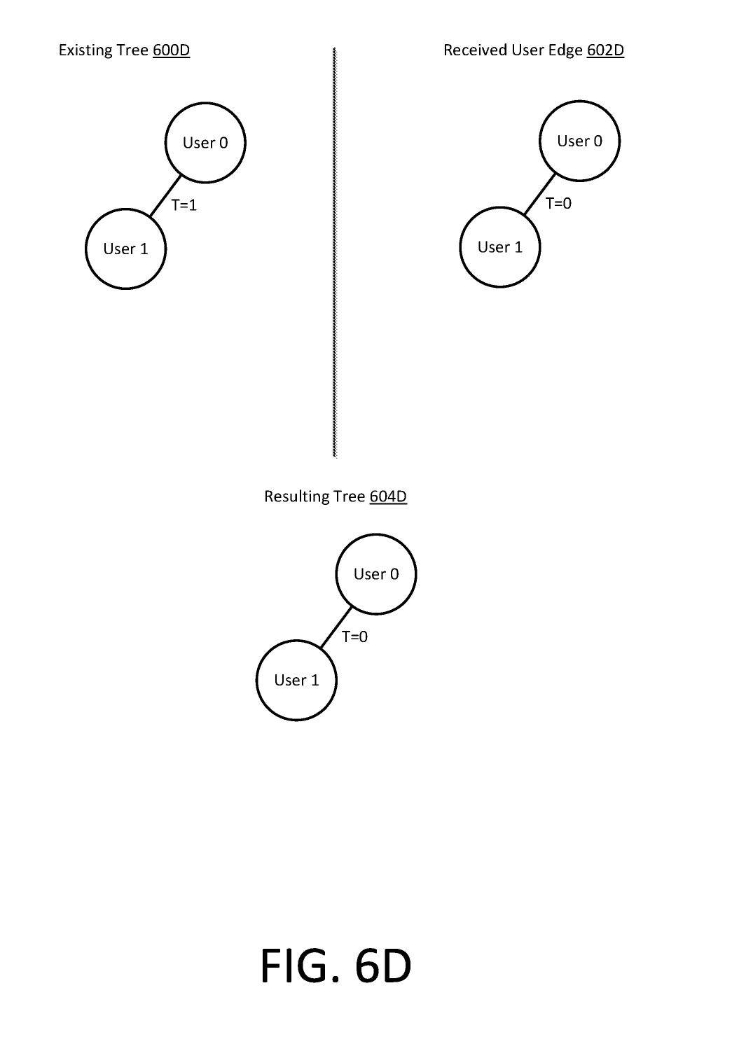

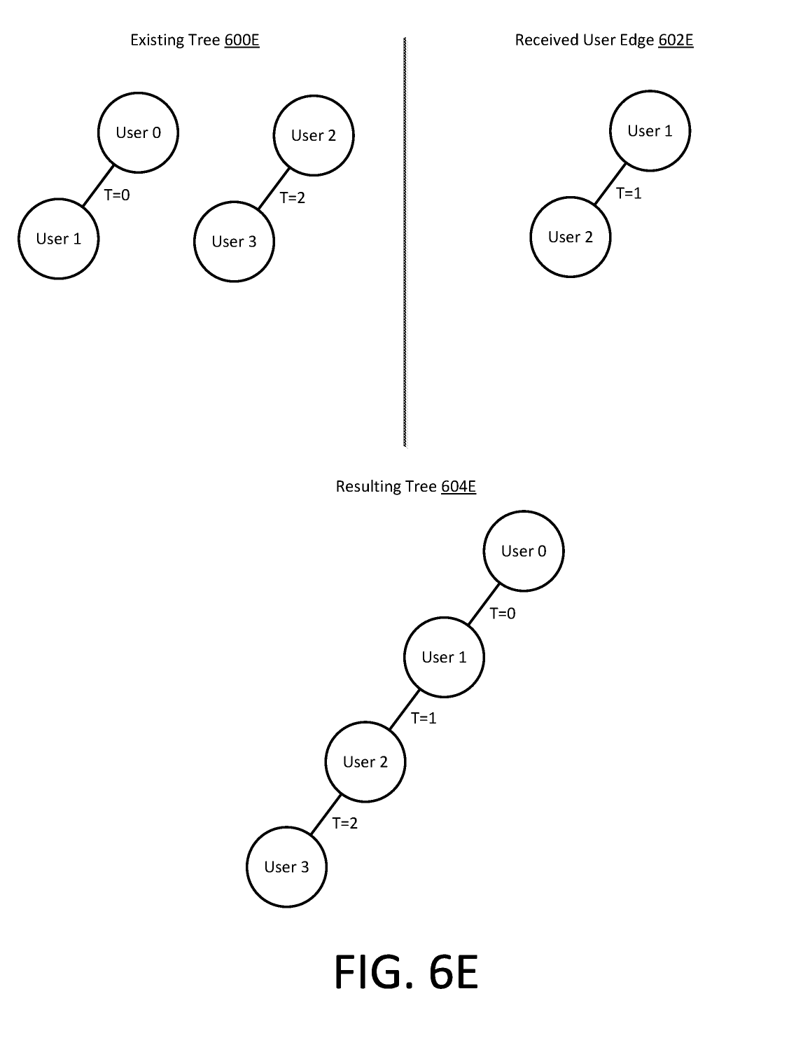

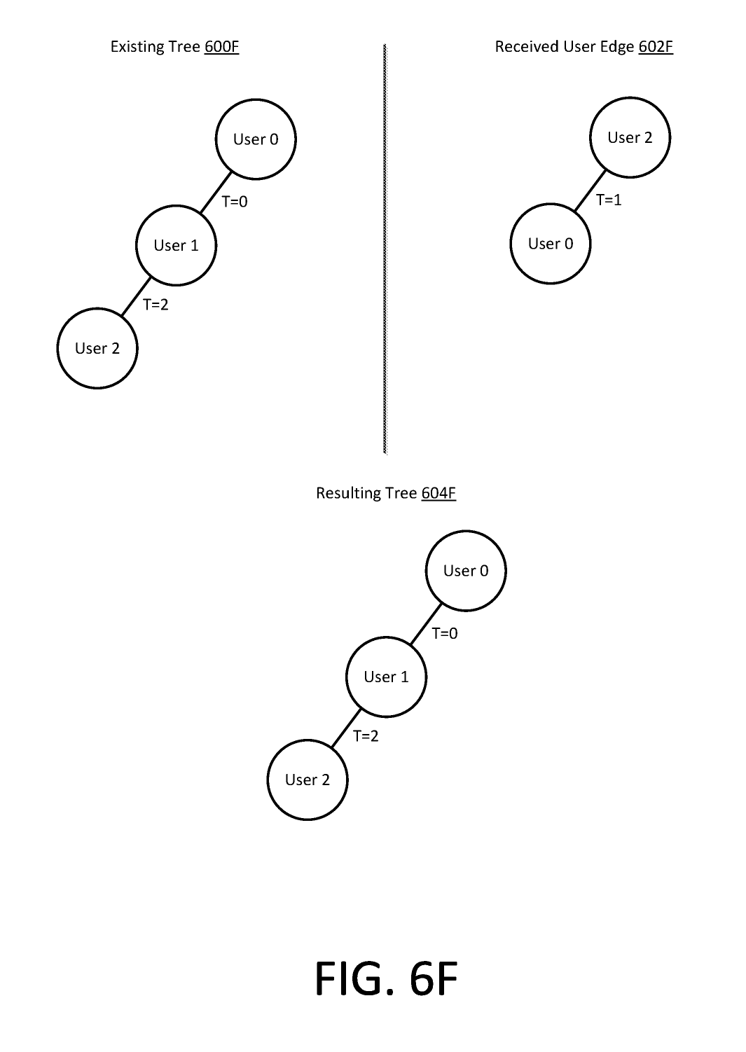

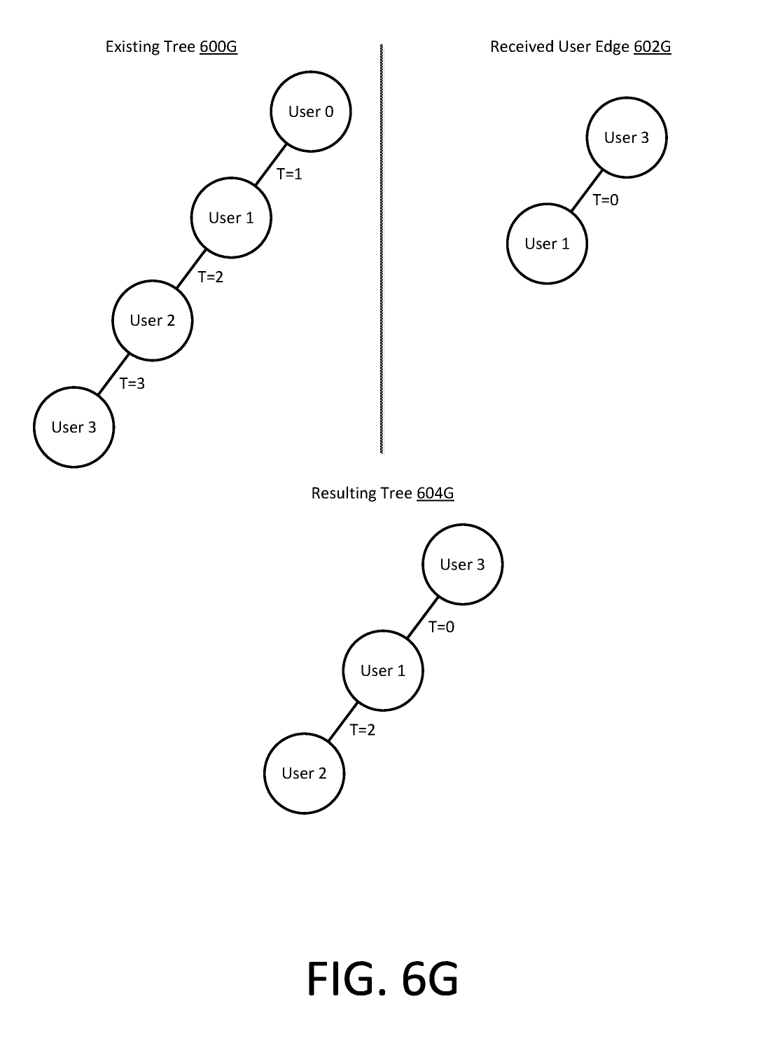

FIGS. 6A-6G are conceptual diagrams illustrating edge logic for a variety of incoming tracking events and states of hierarchical tree structure in the tracking database in accordance with one embodiment.

FIG. 6A illustrates the process of appending an existing tree 600A with a received user edge 602A. In this case, the existing tree 600A is comprised of two nodes 500 representing user 0 and user 1 with an edge 502 between them. The edge 502 has a timestamp of T=0 indicating that user 0 shared the web content 102 with user 1 at T=0. The edge logic module 402 receives a new user edge 602A wherein the sharer node is a node is a pre-existing node (in this case representing user 1). The timestamp of the user edge 602A is at time T=1. After determining that the sharing node of the new user edge 602A already exists in the tree for the web content 102, edge logic module 402 checks to see if the branch of the tree is in chronological order. If these two conditions are satisfied the new user edge 602A is appended to the existing tree 600A resulting in the tree 604A. The preexisting node representing user 1 is maintained and an edge having a timestamp T=1 is appended to the user 1 node, connecting it to the user 2 node.

FIG. 6B illustrates the process of appending an existing tree 600B with a received user edge 602B. In this case, existing tree 600B is comprised of a node 500 representing user 0 connecting to a node 500 representing user 1 with a timestamp of T=1. The received user edge 602B is a user edge 502 connecting the user 2 node at T=0. The logic module 402 determines that if the new user edge 602B was added to the hierarchical tree structure the user 1 node would be subordinate to both user 0 and user 2 nodes. This is not permissible in a directed acyclic graph. Thus the edge logic module 402 keeps the user edge with an earlier timestamp since that is when the receiving user received the information about the web content 102. Therefore the resulting tree 604B is the same as the received user edge 602B.

FIG. 6C illustrates the process of appending an existing tree 600C with a received user edge 602C. In this case, the received user edge 602C is a duplicate user edge to the existing tree 600C. The only difference is that time stamp for the received user edge 602C is later (T=1) than the original timestamp on the existing tree 600C (T=0). Because the earlier timestamp more accurately reflects the transmission of information the timestamp in the existing tree 600C is maintained and the received user edge is discarded. Duplicate user edges 502 may be created if a user reloads a webpage 101 or returns to the webpage 101 at a later time.

FIG. 6D illustrates the process of appending an existing tree 600D with a received user edge 602D. In this case, the received user edge 602D is again a duplicate of the existing tree 600D but also has the earlier timestamp. Therefore the edge logic module 402 updates the existing tree 600D with the new information about the time when the webpage was first shared with user 1.

FIG. 6E illustrates the process of appending an existing tree 600E with a received user edge 602E. In this case, the existing tree 600E is comprised of two trees. One tree is comprised of nodes for user 0 and user 1 connected at timestamp T=0. The second tree is comprised of nodes for user 2 and user 3 connected at timestamp T=2. The received user edge 602E connects two preexisting nodes user 1 and user 2. The edge logic module 402 evaluates whether the sharer ID in the received user edge 602E corresponds to any leaves (subordinate nodes) of the existing trees 600E. The edge logic module 402 then determines if any superior nodes correspond with the current client ID. If both these conditions are satisfied then a subtree migration may be performed. The received user edge 602E is appended to the first of the two preexisting trees and the second tree is migrated and appended to the end of the tree resulting in a tree 604E containing all 4 nodes.

FIG. 6F illustrates the process of appending an existing tree 600F with a received user edge 602F. In this case, the existing tree 600F is comprised of a user 0 node connected to a user 1 node at T=0 and the user 1 node is connected to the user 2 node at T=2. The received user edge 602F is an edge between user 2 and user 0 at T=1. The edge logic module 402 determines that the received user edge would cause a cycle as it is composed of two pre-existing nodes but the subordinate node in the received user edge corresponds to a superior node in the existing tree. In response to determining that a cycle is present, the edge logic module 402 determines whether there are any edges from the superior node (in this case user 0) that predate the timestamp of the received user edge 602F. In this example, the timestamp of the edge connecting user 0 to user 1, T=0, is before the timestamp of the received user edge 602F at T=1. Thus the received user edge 602F does not provide new information since user 0 had already shared the web content 102 before the received user edge 602F was created. Therefore the received user edge 602F is rejected and the resulting tree 604F is the same as the existing tree 600F.

FIG. 6G illustrates the process of appending an existing edge 600G with a received user edge 602G. In this case, the preexisting tree 600G is comprised of 4 nodes user 0, user 1, user 2, and user 3 connected in succession time timestamp T=1, T=2, and T=3 for each respective edge. The received user edge 602G is once again comprised of two nodes that are present in the existing tree 600G user 3 and user 1. Similar to FIG. 6F the order of the nodes is reversed when compared to the existing tree 600G, where the subordinate node, user 3, is the superior node in the received user edge 602G. This triggers the edge logic module 402 to determine whether any of the edges connecting to the superior node of the received user edge 602G predate the timestamp of the received user edge 602G. In this case, the edge directed to the user 1 node indicates the first time at which user 1 had access to the webpage 101. This edge has a timestamp of T=1 which is later than the timestamp of the received user edge 602G. Thus, the edge logic module 402 modifies the existing tree 600G such that the received user edge 602G replaces the edge between user 0 and user 1. The user 3 node is moved from its subordinate position connected to user 2 to a superior position in the resulting tree 604G.

Database modification module 404 includes algorithms for achieving fast sub-tree migration and node replacement in sharing database 110. Any efficient algorithm operating on a directed acyclic graph may be used to accomplish the processes described with respect to FIGS. 6A-6G. Upon receiving a determination from the edge logic module 402 the database modification module 404 accesses the sharing database and performs the necessary changes to incorporate new user edges 502 into the hierarchical tree structure 112.

User interface module 406 provides analytics and visualization functionality to the operator of the website 100. The user interface module 406 provides a user interface to the operator of the websites that allows the operator to access a number of analytics and visualization tools. Operators of the website may access the user interface provided by the user interface module 406 through a browser or desktop application. Analytics and visualization tools provided by the user interface module 406 may be implemented on the same server as the sharing database to minimize data accessing times.

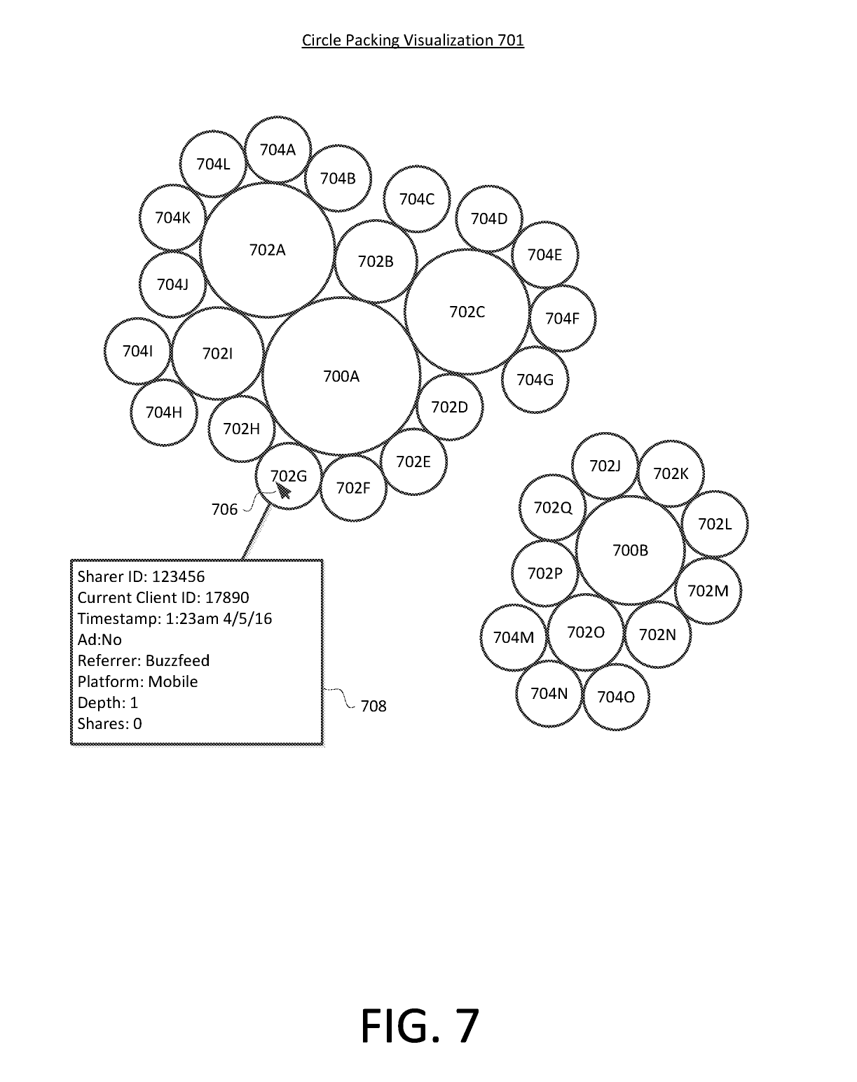

To provide visualization functionality, the user interface module 406 locates the tree in the sharing database 110 and may run any suitable visualization software to display the shape and size and structure of the tree representing the sharing pattern of the item of web content 102 to the operator of the website. One specific visualization is a circle packing visualization 701 tool described with reference to FIG. 7.

FIG. 7 is an illustration of an example tree visualized using a circle packing visualization 701 in accordance with one embodiment. Each circle in the circle packing visualization 701 shown in FIG. 7 represents a node. Two circles contacting one another represents an edge between the nodes represented by the touching circles. The circumference of each circle is proportional to the number of edges that include the node represented by the circle so that circles with greater circumferences may accommodate more contacting circles around them.

Circles 700A and 700B indicate seed nodes that represent original sharers of the associated web content 102. Theses nodes might represent, for example, the authors of the particular content, the operator of the website, or an original hyperlink to the web content 102 on a webpage 101 or third party social network. In many cases, only one seed node is present because oftentimes content is originally shared in a single location. However, when the content is originally shared in multiple locations multiple seed nodes may be present for the same content. The circles surrounding each of the seed nodes 700 are nodes that are included in each tree in the one or more trees associated with a particular content ID. Although two seed nodes 700 are shown in the example of FIG. 7, any number of seed nodes 700 may be present in the diagram depending on the number of seeds for the associated web content 102.

Circles 702A-702Q represent nodes with first degree connections to either one of the two seed nodes 700. Therefore, each node represented by circles 702A-702Q has an edge 502 that represents a sharing event between the users represented by each node.

Circles 704A-704O represent nodes that are second degree connections with the seed nodes. Thus, there are two edges 502, representing sharing events, between each node represented by circles 704 and a seed node. Only two levels of depth are shown in FIG. 7, however circles would continue to be added to the perimeter of circles 704 if users represented by those nodes continue to share the content.

The evaluation module 406 may display a pop-up window 708 or other descriptive text when a website operator hovers-over a circle in the circle packing visualization 701. FIG. 7 shows a mouse pointer of a website operator 706 hovering over circle 702G. The pop-up window may include any of the information contained in a tracking event 300 represented by the edge connecting to a particular circle. In some embodiments, the pop-up window may contain additional data for the node including the number of shares (equal to the number of connecting edges 502) and the depth of the node in the tree structure.

In some embodiments, the evaluation module may provide a zooming feature where a website operator may zoom in on a particular region of the circle packing visualization 701 to inspect circles that may not be visually discernable at the default scaling.

In some embodiments, the circles in the circle packing visualization 701 may be color cording according to the referrer 312 or the platform 314 of the node represented by each circle.

The circle packing visualization 701 shown in FIG. 7 provides the website operator with at-a-glance data of sharing patterns that are normally difficult to interpret. As previously described, circles with a larger circumference represent users that have shared the web content 102 with a larger number of other users. Thus, by inspecting the nodes represented by the larger circles, a website operator may determine which users, locations on their homepage, or seed hyperlinks on third party social networks are responsible for the majority of the sharing propagation of that particular web content 102. The website operator may then make seeding decisions or content decisions based on the circle packing visualization 701.

In addition to providing visualization tools, the user interface module 406 also provides options for the user to calculate metrics for the sharing data associated with a particular web content. These metrics may include but are not limited to calculating the total number of propagations for trees associated with web content 102, calculating the penetration depth, and calculating the shareability of web content 102.

The total propagations metric is calculated by counting the number of nodes in a tree and represents the number of users that have viewed the content. Without the ability to create the tree structures with distinct nodes using the above described method, website operators are limited to estimating the total number of viewing users by using the number of page views of a website 101. However, determining the total propagation of web content 102 is more accurate and informative as repeated visits to the same page are not counted because a user that has viewed a page multiple times would be identified and assigned a single client ID and thus would be represented by only a single node.

The maximum penetration metric is calculated by determining the greatest number of edges 502 between a leaf node and seed node. The maximum penetration depth is one mean of measuring the virality of web content 10 and is often correlated with a large total propagation value. However, if web content 102 has a relatively low total propagation value and a high maximum penetration depth it might indicate that the web content is especially interesting but only for a small audience. These details cannot be determined from page views alone. In some embodiments, an average penetration depth can also be calculated.

The average shareability metric is calculated by averaging the number of edges connected to each node in the tree for web content 102. The average shareability metric is indicative of wide appeal for the web content 102 and is another possible indicator of virality.

The propagation speed metric is calculated by averaging, over each node in the in the tree for web content 102, the time difference between the timestamp of the edge connecting to the node and the timestamps of the edges connected to leaf nodes of the nodes. This metric represents the average time between when a user receives the web content 102 and when the user shares that content with another user. A fast propagation speed indicates particularly compelling content and potential for virality.

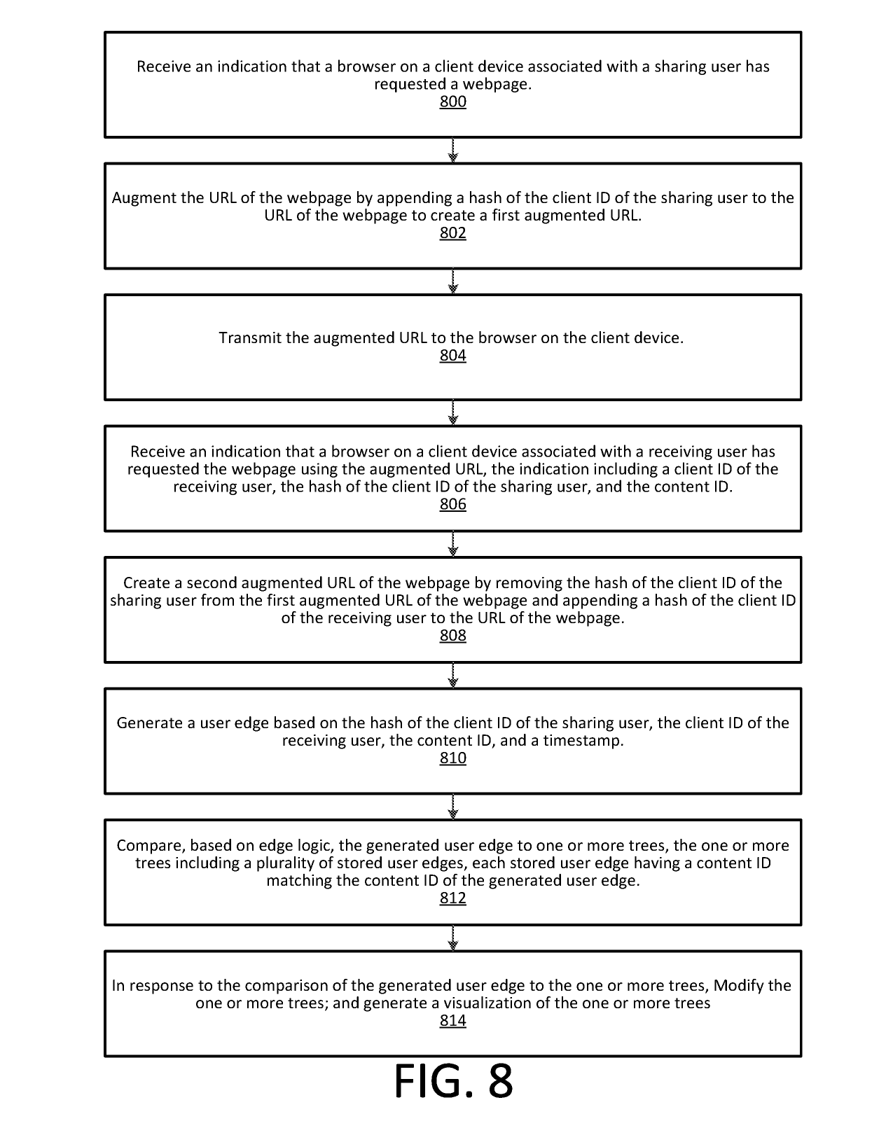

FIG. 8 is a flow diagram illustrating a method for tracking internet sharing in accordance with one embodiment. In step 800, tracking system 114 receives 800 an indication that a browser associated with a sharing user has requested a webpage. The webpage has a URL and the indication includes a client ID of the sharing user and a content ID representing the content on the webpage.

In step 802, tracking system 114 augments 802 the URL of the webpage by appending a hash of the client ID of the sharing user to the URL of the webpage to create a first augmented URL. In some embodiments, the augmentation process is completed by appending a random salt to the client ID of the sharing user, and then using a suitable hashing algorithm to hash the client ID and random salt. The resulting hash is then appended to the URL of the webpage to create the augmented URL.

In step 804, the tracking system 114 then transmits 804 the augmented URL to the browser on the client device. This allows the browser to rewrite the URL displayed in the URL bar of the browser so that the browser instead displays the augmented URL. Upon completing the URL rewrite the tracking system 114 provides the webpage to the browser of the client device associated with the sharing user for display to the sharing user.

In step 806, the tracking system 114 then receives an indication that a browser on a client device associated with a receiving user has requested the webpage using the augmented URL, the indication including a client ID of the receiving user, the hash of the client ID of the sharing user, and the content ID. By receiving the indication the tracking system can identify the sharing user from the hashed client ID of the sharing user that is contained in the augmented URL

In step 808, the tracking system 114 creates 808, a second augmented URL of the webpage by removing the hash of the client ID of the sharing user from the first augmented URL of the webpage and appending a hash of the client ID of the receiving user to the URL of the webpage. The second augmented URL is created in the same way as the first augment URL by appending a random salt to the client ID of the receiving user and then creating a hash of that ID. The second augmented ID may then be used to identify sharing events between the receiving user in this event and future receiving users.

In step 810, the tracking system 114 generates 810 a user edge based on the hash of the client ID of the sharing user, the client ID of the receiving user, the content ID, and a timestamp. The generated user edge contains the available information from the URL that the receiving user used to access the webpage to determine that the receiving user received the URL to the webpage from the sharing user.

After the user edge is generated the webpage is provided the to the browser of the client device associated with the receiving user allowing the user to view the webpage.

In step 812, the tracking system 114 compares, based on edge logic, the generated user edge to one or more trees including a plurality of edges, each of the stored user edges having a content ID matching the content ID of the generated user edge. The trees are stored in the sharing database 110 and are comprised of a number of previously generated user edges described sharing events. The edge logic may be comprised of a series of tests that determine how the one or more trees with matching content IDs should modified based on the generated user edge. The edge logic is described above with reference to FIGS. 6A-6G.

In step 814, the tracking system 114 modifies 814 the one or more trees in response to the comparison in step 812. The modifications to the one or more trees can include sub-tree migrations, appending the generated user edge to the one or more trees, deleting one of the stored user edges, and updating the timestamp of one of the stored user edges.

The tracking system 114 then generates 814 a visualization of the modified one or more trees. The visualization may be a circle packing visualization 701 701 described with respect to FIG. 7 above.

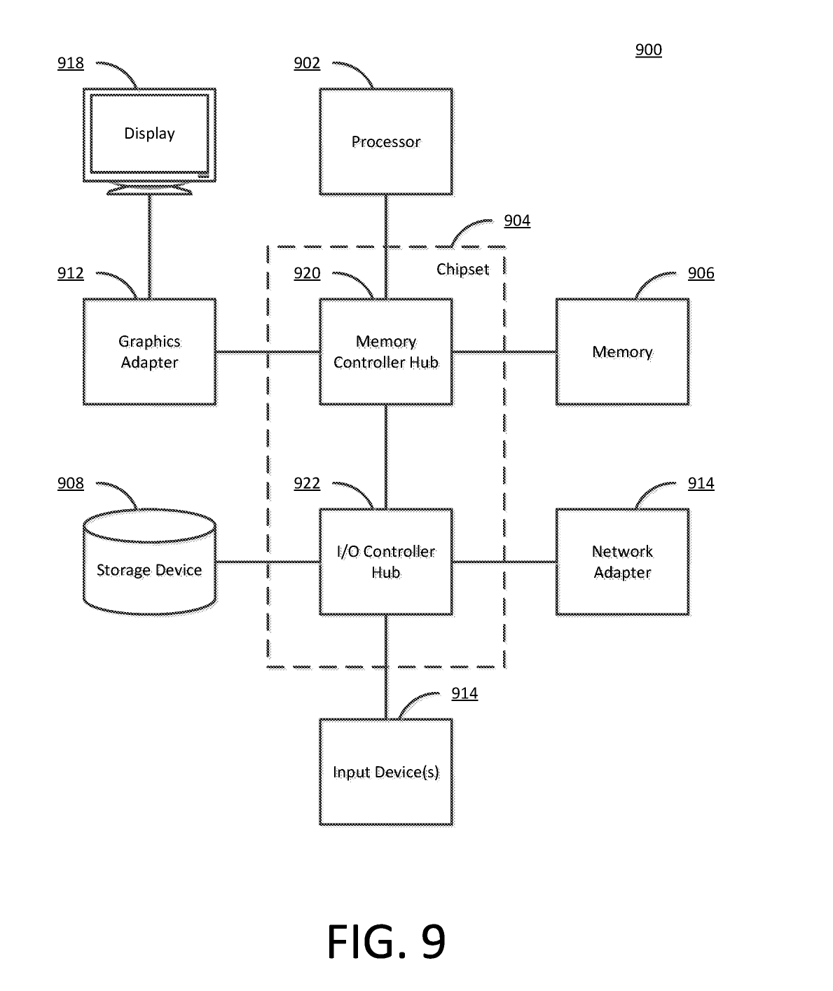

FIG. 9 is a high-level block diagram of the components of a computing system 900 for use as the data collection system 104 or data integration system 112, according to one embodiment. The computing system 900 includes at least one processor 902 coupled to a chipset 904. Also coupled to the chipset 904 are a memory 906, a storage device 908, a graphics adapter 912, input device(s) 914, and a network adapter 916. A display 918 is coupled to the graphics adapter 912. In one embodiment, the functionality of the chipset 904 is provided by a memory controller hub 920 and an input/output (I/O) controller hub 922. In another embodiment, the memory 906 is coupled directly to the processor 902 instead of the chipset 904.

The processor 902 is an electronic device capable of executing computer-readable instructions held in the memory 906. In addition to holding computer-readable instructions, the memory 906 also holds data accessed by the processor 902. The storage device 908 is a non-transitory computer-readable storage medium that also holds computer readable instructions and data. For example, the storage device 908 may be embodied as a solid-state memory device, a hard drive, compact disk read-only memory (CD-ROM), a digital versatile disc (DVD), or a BLU-RAY disc (BD). The input device(s) 614 may include a pointing device (e.g., a mouse or track ball), a keyboard, a touch-sensitive surface, a camera, a microphone, sensors (e.g., accelerometers), or any other devices typically used to input data into the computer 900. The graphics adapter 912 displays images and other information on the display 918. In some embodiments, the display 918 and an input device 914 are integrated into a single component (e.g., a touchscreen that includes a display and a touch-sensitive surface). The network adapter 916 couples the computing device 900 to a network, such as the network 102.

A computer 900 can have additional, different, and/or other components than those shown in FIG. 9. In addition, the computer 900 can lack certain illustrated components. In one embodiment, a computer 900 acting as a server may lack input device(s) 914, a graphics adapter 912, and/or a display 918. Moreover, the storage device 908 can be local and/or remote from the computer 900. For example, the storage device 908 can be embodied within a storage area network (SAN) or as a cloud storage service.

The computer 900 is adapted to execute computer program modules for providing functionality described herein. As used herein, the term “module” refers to computer program logic utilized to provide the specified functionality. Thus, a module can be implemented in hardware, firmware, and/or software. In one embodiment, computer program modules are stored on the storage device 908, loaded into the memory 906, and executed by the processor 902.

Some portions of the above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for generating messaging directories and messaging members of those directories. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed herein.

1. A computer implemented method for tracking content diffusion over a network, the method comprising:
receiving a first indication that a browser on a client device associated with a sharing user has requested a webpage having a URL, the first indication including a client ID of the sharing user and a content ID;
augmenting the URL of the webpage by appending a hash of the client ID of the sharing user to the URL of the webpage to create a first augmented URL;
transmitting the augmented URL to the browser on the client device;
providing the webpage to the browser of the client device associated with the sharing user;
receiving a second indication that a browser on a client device associated with a receiving user has requested the webpage using the augmented URL, the second indication including a client ID of the receiving user, the hash of the client ID of the sharing user, and the content ID;
creating a second augmented URL of the webpage by removing the hash of the client ID of the sharing user from the first augmented URL of the webpage and appending a hash of the client ID of the receiving user to the URL of the webpage;
generating a user edge based on the hash of the client ID of the sharing user, the client ID of the receiving user, the content ID, and a timestamp;
providing the webpage to the browser of the client device associated with the receiving user;
comparing, based on edge logic, the generated user edge to one or more trees, the one or more trees including a plurality of stored user edges, each stored user edge having a content ID matching the content ID of the generated user edge;
in response to the comparison of the generated user edge to the one or more trees:
modifying the one or more trees; and
generating a visualization of the modified one or more trees.

2. The method of claim 1, wherein modifying the one or more trees further comprises performing at least one of:
performing sub-tree migration between two of the one or more trees,
appending the generated user edge to the one or more trees,
deleting one of the stored user edges, and
updating the timestamp of one of the stored user edges.

3. The method of claim 1, wherein each node of one or more trees represents a client ID of a user in a user edge and wherein each edge between two nodes of the one or more trees represents a tracking event.

4. The method of claim 3, wherein comparing, based on edge logic further comprises:
responsive to determining that a first stored edge between nodes representing client IDs of the sharing user and the receiving user exists in the one or more trees, and
responsive to determining that the timestamp of the generated user edge is before the timestamp of the first stored edge in the one or more trees:
updating the timestamp of the first stored edge to the timestamp of the generated user edge.

5. The method of claim 3, wherein comparing, based on edge logic further comprises:
responsive to determining that nodes representing the client IDs of the sharing user and the receiving user exist in the one or more trees, and
responsive to determining that there is no edge between the nodes representing the client IDs of the sharing user and the receiving user:
performing a sub-tree migration by migrating descendent nodes of the node representing the client ID of the receiving user to a branch of a tree of the one or more trees descending from the node representing the client ID of the sharing user.

6. The method of claim 3, wherein comparing, based on edge logic further comprises:
responsive to determining that the addition of the generated user edge to the one or more trees would result in a cycle in the one or more trees, and
responsive to determining that the timestamp of the generated user edge is before edges including nodes representing the client IDs of the sharing user and the receiving user:
removing edges having a timestamp later than the timestamp of the generated user edge and including the node representing the sharing user as a subordinate node;
removing edges having a timestamp later than the timestamp of the generated user edge and including the node representing the receiving user as a subordinate node; and
appending the user edge to the one or more trees.

7. The method of claim 1, wherein visualizing the one or more trees further comprises generating a circle packing visualization.

8. The method of claim 7, wherein the circle packing visualization further comprises:
generating a plurality of circles, each circles representing a node in the one or more trees; and
displaying the circles such that directly adjacent circles represent an edge between nodes represented by the adjacent circles.

9. The method of claim 1, wherein generating a user edge further comprises:
generating the user edge based on attributes of the first and second indication including at least one of:
an attribute indicating a referring website, and
an attribute indicating a platform of the first or second indications.

10. A system for tracking content diffusion over a network, the system comprising:
a computer processor for executing computer program instructions; and
a non-transitory computer readable storage medium storing computer program instructions executable to perform steps comprising:
receiving a first indication that a browser on a client device associated with a sharing user has requested a webpage having a URL, the first indication including a client ID of the sharing user and a content ID;
augmenting the URL of the webpage by appending a hash of the client ID of the sharing user to the URL of the webpage to create a first augmented URL;
transmitting the augmented URL to the browser on the client device;
providing the webpage to the browser of the client device associated with the sharing user;
receiving a second indication that a browser on a client device associated with a receiving user has requested the webpage using the augmented URL, the second indication including a client ID of the receiving user, the hash of the client ID of the sharing user, and the content ID;
creating a second augmented URL of the webpage by removing the hash of the client ID of the sharing user from the first augmented URL of the webpage and appending a hash of the client ID of the receiving user to the URL of the webpage;
generating a user edge based on the hash of the client ID of the sharing user, the client ID of the receiving user, the content ID, and a timestamp;
providing the webpage to the browser of the client device associated with the receiving user;
comparing, based on edge logic, the generated user edge to one or more trees, the one or more trees including a plurality of stored user edges, each stored user edge having a content ID matching the content ID of the generated user edge;
in response to the comparison of the generated user edge to the one or more trees:
modifying the one or more trees; and
generating a visualization of the modified one or more trees.

11. The system of claim 10, wherein modifying the one or more trees further comprises performing at least one of:
performing sub-tree migration between two of the one or more trees,
appending the generated user edge to the one or more trees,
deleting one of the stored user edges, and
updating the timestamp of one of the stored user edges.

12. The system of claim 10, wherein each node of one or more trees represents a client ID of a user in a user edge and wherein each edge between two nodes of the one or more trees represents a tracking event.

13. The method of claim 12, wherein comparing, based on edge logic further comprises:
responsive to determining that a first stored edge between nodes representing client IDs of the sharing user and the receiving user exists in the one or more trees, and
responsive to determining that the timestamp of the generated user edge is before the timestamp of the first stored edge in the one or more trees:
updating the timestamp of the first stored edge to the timestamp of the generated user edge.

14. The method of claim 12, wherein comparing, based on edge logic further comprises:
responsive to determining that nodes representing the client IDs of the sharing user and the receiving user exist in the one or more trees, and
responsive to determining that there is no edge between the nodes representing the client IDs of the sharing user and the receiving user:
performing a sub-tree migration by migrating descendent nodes of the node representing the client ID of the receiving user to a branch of a tree of the one or more trees descending from the node representing the client ID of the sharing user.

15. The system of claim 12, wherein comparing, based on edge logic further comprises:
responsive to determining that the addition of the generated user edge to the one or more trees would result in a cycle in the one or more trees, and
responsive to determining that the timestamp of the generated user edge is before edges including nodes representing the client IDs of the sharing user and the receiving user:
removing edges having a timestamp later than the timestamp of the generated user edge and including the node representing the sharing user as a subordinate node;
removing edges having a timestamp later than the timestamp of the generated user edge and including the node representing the receiving user as a subordinate node; and
appending the user edge to the one or more trees.

16. The system of claim 10, wherein visualizing the one or more trees further comprises generating a circle packing visualization.

17. The system of claim 17, wherein the circle packing visualization further comprises:
generating a plurality of circles, each circles representing a node in the one or more trees; and
displaying the circles such that directly adjacent circles represent an edge between nodes represented by the adjacent circles.

18. The system of claim 10, wherein generating a user edge further comprises:
generating the user edge based on attributes of the first and second indication including at least one of:
an attribute indicating a referring website, and
an attribute indicating a platform of the first or second indications.
